(19) United States
(12) Patent Application Publication
(10) Pub. No.: US 2024/0141711 A1
(43) Pub. Date: May 2, 2024

(54) Movable Barrier Operator With Ultra-Wideband Device

(71) Applicant: The Chamberlain Group LLC, Oak Brook, IL (US)

(72) Inventors: Casparus Cate, Murfreesboro, TN (US); Michael Joseph Davies, Woodridge, IL (US); Benjamin David Hunt, Oak Park, IL (US); Thomas Jason Jankovsky, Elgin, IL (US); Paul Anthony Kuzich, Arlington Heights, IL (US); Michael Joseph Phillips, Oak Park, IL (US); Maged Riad, Roselle, IL (US)

(21) Appl. No.: 18/383,278

(22) Filed: Oct. 24, 2023

Related U.S. Application Data
(60) Provisional application No. 63/419,977, filed on Oct. 27, 2022.

(51) Int. Cl. E05F 15/668

(52) U.S. Cl. CPC E05F 15/668; E05Y 2400/664; E05Y 2900/106

(57) ABSTRACT

In one aspect, a system includes a movable barrier operator configured to open and close a movable barrier; at least one ultra-wideband device associated with the movable barrier operator and electrically configured to receive ultra-wideband radio frequency signals; and a processor operatively connected to the at least one ultra-wideband device and configured to use the ultra-wideband radio signals to determine a status of the movable barrier.

### CROSS REFERENCE TO RELATED APPLICATIONS

This application claims the benefit of U.S. Provisional Patent Application No. 63/419,977, filed on Oct. 27, 2022, entitled, “Movable Barrier Operator With Ultra-Wideband Device” the entirety of which is incorporated herein by reference.

### TECHNICAL FIELD

This disclosure relates to movable barrier operator systems and, more specifically, to movable barrier operator systems that consider the proximity of a user or a device as part of the operation of the movable barrier operator system.

### BACKGROUND

Various types of movable barrier operator systems are known such as garage door operators, gate operators, rolling shutter systems, and pet access systems. Examples of movable barriers include garage doors, swinging or sliding gates, shutters, pet doors, etc. Movable barriers are movable between closed and open positions to allow ingress and egress of vehicles, people, pets, etc. to and from various secured areas such as a garage of a home. Some operations of these systems may be automatically enabled or triggered based on a location of a detected device associated with a user of the system.

Some garage door operators have features in which a user verifies the user's proximity to a garage door operator using buttons on the garage door operator itself, such as during installation of the garage door operator or performing maintenance on the garage door operator. However, because many garage door operators are installed near a ceiling of the associated garage, actuating the buttons entails a user climbing a ladder to access the buttons during installation or maintenance of the garage door operator. Thus, it may be difficult for a user to install and/or perform maintenance on a garage door operator if the user is unable to climb a ladder.

### BRIEF DESCRIPTION OF THE DRAWINGS

FIG. 1 is a view of an example movable barrier operator system for operating a movable barrier;

FIG. 2 is a schematic plan view of the movable barrier operator system and garage of FIG. 1;

FIG. 3 is an environmental view of an example pet access system in the context of a kitchen of a home; and

FIGS. 4-5 are flow diagrams of example methods of operating a movable barrier operator.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein that utilize ultra-wideband devices to facilitate one or more operations of a movable barrier operator system and/or a pet access system. In particular, such systems and methods described herein in can utilize ultra-wideband devices and signals to determine a status of a movable barrier and/or to trigger various different system operations for the movable barrier operator system based on distance information and/or identification information derived from ultra-wideband signals emitted and/or received by an ultra-wideband device.

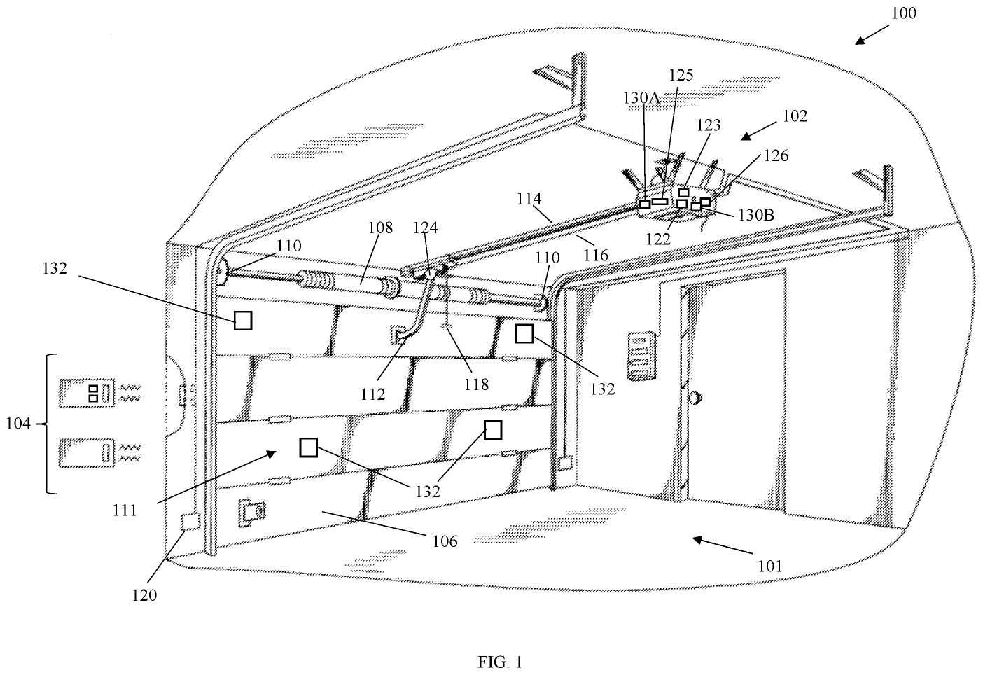

Referring now to FIG. 1, an example movable barrier operator system 100 is provided for operating a movable barrier such as a movable barrier 106 that limits access to a secured area such as a garage 101. In one embodiment, the movable operator system 100 includes a movable barrier operator 102 and one or more remote controls such as a transmitter 104. The one or more remote controls may also include, for example, a user device such as a smartphone, a laptop computer, a tablet computer, an in-vehicle device such as an infotainment system coupled to an in-vehicle transmitter, a keypad external to the garage 101, a wall control, a visor-mounted remote control, and/or a handheld transmitter such as a key fob. The movable barrier operator 102 includes an electric motor 122, communication circuitry 123, and a control circuit (including a processor 125 and a memory 126). The processor 125 may include, for example, a microprocessor, a system-on-a-chip, an application specific integrated circuit (ASIC), and/or a field programmable gate array (FPGA). The memory 126 may include, for example, an electrical charge-based storage media such as EEPROM or RAM, or other non-transitory computer readable media.

In some embodiments, the movable barrier operator includes a rail 116 and transmission member 114 such as a chain, belt, or screw driven by the motor 122 relative to the rail 116. The electric motor 122 is operable to move the movable barrier 106 between open and closed positions. For example, a trolley 124 is coupled to the transmission member 114 as well as an arm 112 that is attached to the movable barrier 106. The motor 122 shifts the trolley 124 back-and-forth along the rail 116 to lift and lower the movable barrier 106. A release mechanism 118 is coupled to the trolley 124 to allow the movable barrier 106 to be disconnected from the movable barrier operator 102 for manual operation such as during a power failure.

The movable barrier operator system 100 includes a drum and cable mechanism 110 that is attached to the movable barrier 106. The drum and cable mechanism 110 includes a drum and a corresponding cable on each side of the movable barrier 106. The cable is taken out from and taken up onto the drum when the movable barrier 106 is respectively lowered and raised. The drum and cable mechanism 110 couples to a counterbalance such as a torsion spring 108 that assists in lifting the weight of the movable barrier 106 and enables the movable barrier operator 102 to open or close the movable barrier 106 via movement of the trolley 124. In some embodiments, an optical device such as a photo eye system 120 senses an object and/or a human who may be in the way of the movable barrier 106 as the movable barrier 106 closes.

The movable barrier operator system 100 also includes one or more ultra-wideband devices 111. The ultra-wideband devices 111 are configured to transmit, receive, or transmit and receive radio frequency signals at a frequency in a range of about 3.1 GHz to about 10.6 GHz. In one embodiment, the movable barrier operator 102 includes ultra-wideband devices 130A and 130B and the movable barrier operator system 100 may include additional ultra-wideband devices 132 of the movable barrier 106. The ultra-wideband devices 132 of the movable barrier 106 may include one or more devices on the inside of the movable barrier 106 and one or more devices on the outside of the movable barrier 106. The ultra-wideband devices 130A and 130B and the ultra-wideband devices 132 operably coupled via wired and/or wireless approaches with the processor 125 of the movable barrier operator 102. For example, the ultra-wideband devices 130A and 130B, when performing the role or function of ultra-wideband anchors, can receive signals from one or more of the ultra-wideband devices 132 performing the role or function as ultra-wideband tags. The ultra-wideband devices 130A, 130B may communicate the received signals to the processor 125 so as to enable the processor 125 to determine a status of the movable barrier 106. The status of the movable barrier 106 may include a status indicating, for example, open, closed, opening, closing, stopped, and/or an intermediate position. Additional ultra-wideband devices may be included in or proximate to the photo eye system 120, a wall controller of the movable barrier operator system 100, an edge sensor, a work light, a red/green parking light system, a door lock, a camera, and/or other devices in the garage 101 to provide a desired level of positioning resolution for the ultra-wideband device being tracked in the garage 101.

The devices 130A, 130B, 132, or any other ultra-wideband devices discussed herein, may utilize other sensing technologies in addition to or instead of ultra-wideband radio signals. For example, the devices 130A, 130B, 132 may utilize millimeter wave (mmWave) radio wave or radar-based approaches. As another example, the devices 130A, 130B, 132 may utilize Bluetooth Channel Sounding (also known as Bluetooth High Accuracy Distance Measurement ‘HADM’).

The ultra-wideband devices 130A and 130B and/or the ultra-wideband devices 132 can be utilized as anchors to receive ultra-wideband signals from ultra-wideband transmitters (e.g., tags) and to communicate those signals to the processor 125 for processing. In particular, the ultra-wide band signals received from the tags can be in response to those tags receiving ultra-wideband and/or Bluetooth signals broadcast from the ultra-wideband devices 130A and 130B and/or the ultra-wideband devices 132. The processor 125 may determine the relative positioning of the transmitters based upon signals received by the ultra-wideband devices 130A, 130B, 132 such as whether a transmitter is within a proximity to the devices 130A, 130B, 132, within a predetermined area of the garage 101, and/or whether the transmitter is inside or outside of the movable barrier 106.

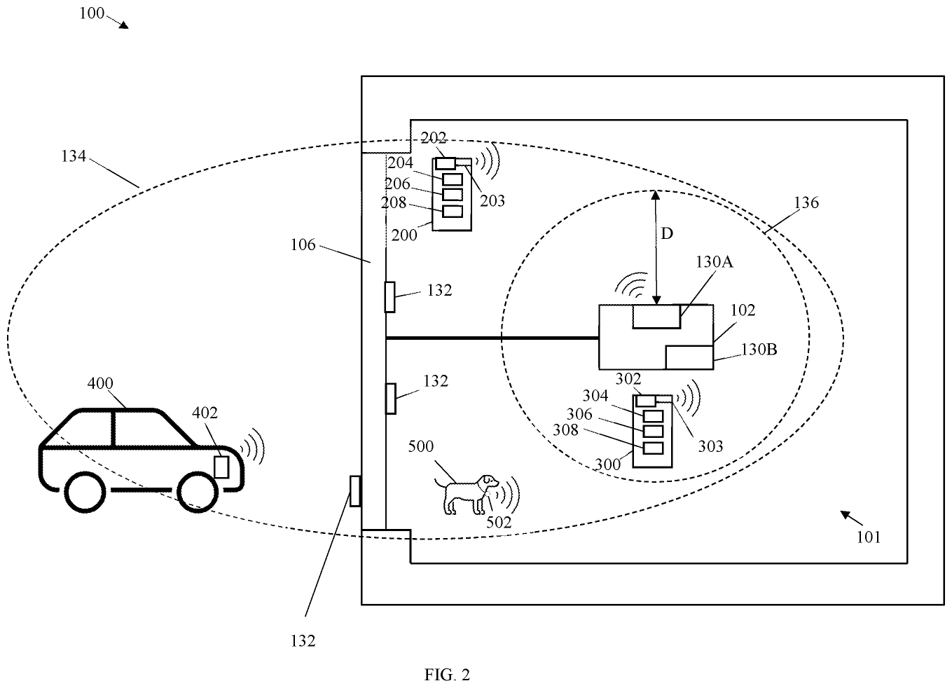

For example and with reference to FIG. 2, these ultra-wideband transmitters can be included with user devices 200 and 300, a vehicle 400, and/or a pet 500. In particular, the user device 200 may include communication circuitry 202 that includes at least one ultra-wideband device 203 (which may include at least one antenna and a radio to transmit and receive ultra-wideband signals), a user interface 204, memory 206, and a processor 208 electrically coupled to the communication circuitry 202, the user interface 204, and the memory 206. The communication circuitry 202 may include one or more communication interfaces, such as a cellular network interface (e.g., 4G, 4G LTE, 5G), a Bluetooth® interface, and/or a Wi-Fi (ID network interface. The user interface 204 may include a display, a touchscreen, a keypad, a microphone, and/or a speaker as some examples. Although the ultra-wideband device 203 is shown to be separate and distinct from the communication circuitry 202, the ultra-wideband device 203 and communication circuitry 202 may be combined, integral or unitary.

The user device 300 may be similar to the user device 200 and may include communication circuitry 302 that includes at least one ultra-wideband device 303 (that may include at least one antenna and a radio to transmit and receive ultra-wideband signals), a user interface 304, memory 306, and a processor 308. Similar to the processor 125, the processors 208 and 308 may include, for example, a microprocessor, a system-on-a-chip, an application specific integrated circuit (ASIC), and/or a field programmable gate array (FPGA). Further, the memories 206 and 306, like the memory 126, may include, for example, an electrical charge-based storage media such as EEPROM or RAM, or other non-transitory computer readable medium. Additionally, as seen in FIG. 2 the vehicle 400 may include an in-vehicle ultra-wideband device 402 and the pet 500 can be outfitted with an ultra-wideband device 502 such as a collar that includes an ultra-wideband antenna and radio. The devices 402, 502 may transmit ultra-wideband signals and, in some embodiments, may receive ultra-wideband signals such as bidirectional communications with ultra-wideband devices 132.

Each of the ultra-wideband devices 203, 303, 402, and 502 can comprise ultra-wideband transmitters and/or receivers configured to broadcast and receive ultra-wideband radio frequency signals. For example, in some embodiments, the ultra-wideband devices 130A and 130B and the ultra-wideband devices 132 may: (1) receive ultra-wideband signals from the ultra-wideband devices 203, 303, 402, and 502 that are within an operating range 134 of the ultra-wideband devices 130A and/or 130B and the ultra-wideband devices 132; and (2) communicate data indicative of the received signals to the processor 125, which can then reliably determine a presence, location, direction of movement, and/or angle of arrival of the ultra-wideband devices 203, 303, 402, or 502 in an environment or space proximate to the movable barrier operator system 100. In some embodiments, the processor 125 can locate the ultra-wideband devices 203, 303, 402, or 502 in three dimensions with an accuracy of approximately 10-20 centimeters or less. Further, in some embodiments, the processor 125 can additionally determine whether the ultra-wideband devices 203 or 303 are located within an area 136 of the garage 101 within a distance D from the movable barrier operator 102. The area 136 may have a generally spherical or circular shape in the garage 101 with a radius that corresponds to the distance D. In other approaches, the area 136 may include two or more subregions and may have different shapes. As one example in this regard, the area 136 may include two or more subregions associated with an ultra-wideband device in two or more corners of the garage 101. Due to the presence of the walls of the garage 101, the area 136 in each corner may have a sector shape with radii that correspond to the range of the ultra-wideband device in the corner. Additional areas of interest within the garage 101 may include an area adjacent the exterior of the movable barrier 106 to facilitate opening and an area adjacent the interior of the movable barrier 106 to facilitate closing In some embodiments, the angle of arrival measurement may be limited to a range of +/−60 degrees with respect to the antennas of the ultra-wideband devices 130A and/or 130B and the ultra-wideband devices 132.

In operation, the processor 125 can perform, trigger, enable, etc. one or more operations of the movable barrier operator 102 in response to the ultra-wideband signals from the ultra-wideband devices 203, 303, 402, or 502. The specific operations facilitated by the processor 125 can be dependent on variety of factors, parameters, or variables. These variables can include the specific one of the ultra-wideband devices 203, 303, 402, and 502 detected by the processor 125 via the ultra-wideband devices 130A and 130B and/or the ultra-wideband devices 132. The variables may include the distance and/or moving direction of the detected one of the ultra-wideband devices 203, 303, 402, and 502. In some embodiments, the processor 125 may identify the specific one of the ultra-wideband devices 203, 303, 402, and 502 that is detected using identification information included in the ultra-wideband signals received by the ultra-wideband devices 130A and 130B and/or the ultra-wideband devices 132.

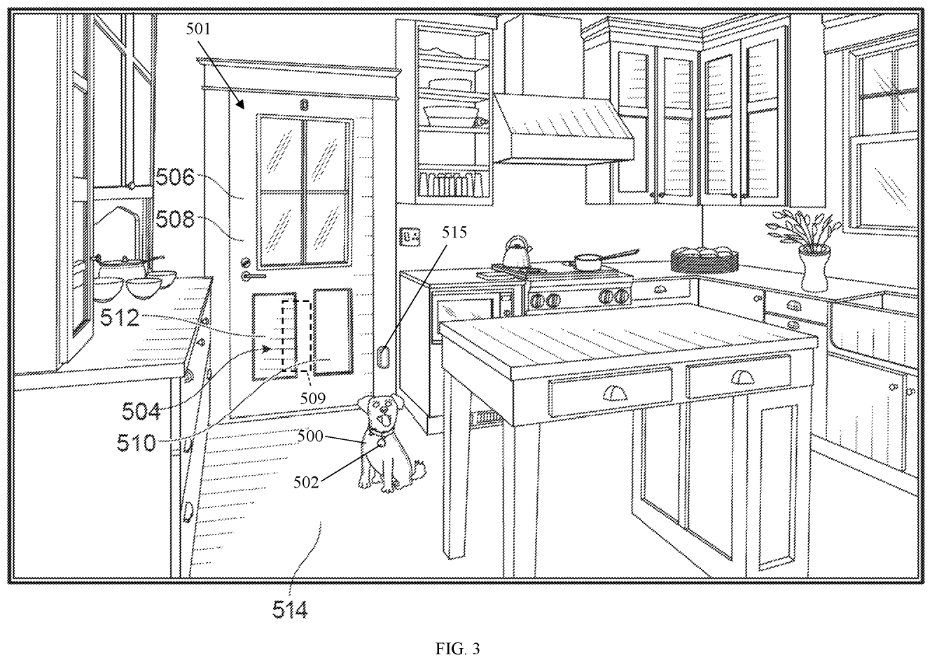

With reference to FIG. 3, the ultra-wideband device 502 associated with the pet 500 may be utilized in connection with a pet access system 501 that includes a door 506. The door 506 includes a pet access apparatus 504 having a pet door 509 which may be opened without the physical presence of a pet owner. The state of the pet door 509 may be controlled, for example, by a motor or linear actuator. As shown in FIG. 3, the pet door 509 may be integrated in the door 506 of a home. The door 506 may, for example, be an interior door (e.g. separating one interior room from another) or an exterior door (e.g. a passageway door from the garage 101 or an outside area) of the home. As one example, the door 506 may be a front door, backdoor, or side door. The door 506 may be constructed of wood, metal, glass, plastic or various combinations thereof. The door 506 may provide passage into a secured area 514, such as the inside of a home.

In FIG. 3, the pet door 509 is in an open position and at least partially within an internal compartment, such as a void or a pocket of, the door 506. The pocket may be defined by a body 508 of the door 506 between substantially parallel, planar internal and external walls of the body 508. With the pet door 509 in the open position, an opening 510 is formed in door 506 sized to permit the pet 500 to travel through the opening 510 into or out of the secured area 514. The pet door 509 closes the opening 510 when the pet door 509 is in a closed position. The pet door 509 may look visually similar to the rest of the door 506. For example, the pet door 509 may look like another panel of the door, such as panel 512, to conceal the pet door 509 when the pet door 509 is closed. Further, the pet access system 501 may include an additional ultra-wideband device 515 that can detect proximity of the pet-carried ultrawideband device 502 and trigger operation of the pet door 509 in response to such detection. The pet access system 501 may have a processor operably coupled to the ultra-wideband device 515 that measures angle of arrival of ultra-wideband signals from the ultra-wideband device 502 to detect whether the ultra-wideband device 502 (and the pet associated therewith) has passed through the opening 510 or not and, if so, what direction the ultra-wideband device 502 was moving.

During setup of the pet access system 501, the user may hold the ultra-wideband device 502 in the user's hand and move gradually toward the pet door 509 until the pet access system 501 detects the ultra-wideband device 502 and opens the pet door 509. The user records the distance, such as by entering the distance into a user device paired with the pet access system 501, and repeats the process with different approach angles to the door to confirm that the ultra-wideband device 502 will open the pet door 509 regardless of the approach angle. Further still, in embodiments where the door 506 is a door into the garage 101, the pet access system 501 may work in conjunction with the movable barrier operator system 100 to additionally operate the movable barrier operator 102 to open the movable barrier 106 to enable the pet 500 to exit the garage 101. Further, the user may manually move the ultra-wideband device 502 through the pet door 509 during setup of the pet access system 501 to confirm that the pet access system 501 detects a correct direction of movement of the ultra-wideband device 502 through the pet door 509.

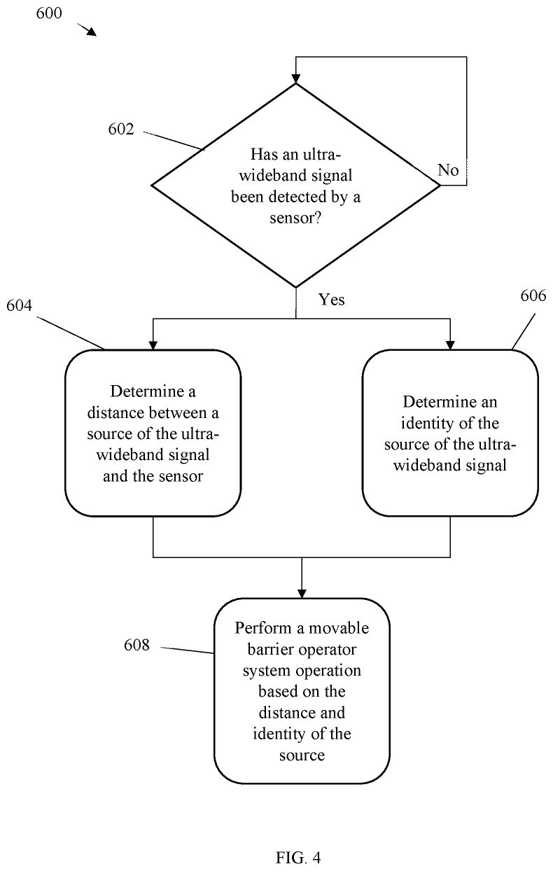

Turning now to FIG. 4, operation of the movable barrier operator system 100 will be described in more detail. A method 600 is provided for operating the movable barrier operator system 100 and may include determining 602 whether an ultra-wideband signal has been detected e.g., by an ultra-wideband device such as an ultra-wideband anchor or a device. In some embodiments, the processor 125 may be configured to perform the determination 602 and the relevant devices being monitored may include the ultra-wideband devices 130A and 130B and the ultra-wideband devices 132. When no ultra-wideband signals have been detected, the method 600 can include continuing to monitor for those signals.

However, when an ultra-wideband signal has been detected at operation 602, the method 600 may include determining 604 a distance between a source of the ultra-wideband signal and the detecting device or from a specific location such as the movable barrier operator 102. The distance between the source and the detecting device may be determined, for example, by calculating a time of flight of the signal. The method 600 may further include determining 606 an identity of the source of the ultra-wideband signal. In some embodiments, the processor 125 can determine 604, 606 the distance and identity of the ultra-wideband signal source such as the ultra-wideband devices 203, 303, 402, or 502 by analyzing data embedded, in and/or the transmission characteristics of, the ultra-wideband signals received by the ultra-wideband devices 130A and 130B and/or the ultra-wideband devices 132. The processor 125 can determine 604, 606 the distance and identity in parallel or serially. The identity and distance may be determined by the processor 125 one after the other in either order. When determining the identity, the processor 125 can retrieve a unique identifier from the ultra-wideband signals and/or other accompanying RF signals such as Bluetooth signals and then match the retrieved unique identifier to a list of unique identifiers stored in the memory 126 that are associated with each of the ultra-wideband devices 203, 303, 402, or 502. Further, in some embodiments, the processor 125 can identify and/or verify the ultra-wideband device whose ultra-wideband signals are received using other credentials such as a signature of ultra-wideband signal. The processor 125 can employ a time-of-flight and angle-of-approach determination on the received ultra-wide band signals to precisely determine the distance information. In some embodiments, the ultra-wideband devices 130A and 130B and the ultra-wideband devices 132 may include multiple antennas to enable precise determination of an angle of approach of the ultra-wideband devices 203, 303, 402, or 502 from a comparison of the signals as received by each of the antennas. The time-of-flight determination can be made using: single sided two way ranging, double sided two way ranging, and/or time difference of arrival techniques. Further, the angle-of-approach determination can be accomplished using a phase difference of arrival method whereby a phase difference between the received ultra-wideband signal at two or more antennas of the ultra-wideband devices 130A and 130B and the ultra-wideband devices 132 is used to determine the angle of approach.

After the direction and identity are determined, the method 600 can include performing 608 a movable barrier operator system operation based on the distance and identity of the source. In some embodiments, the system operation may be performed after the processor 125 has identified and/or verified that the ultra-wideband signal has been received from a known source such as one of the ultra-wideband devices 203, 303, 402, or 502. The system operation may be selected based on a combination of the identity of the ultra-wideband device and the distance and may include one or more different operations such as a state change operation, an anti-entrapment operation, and/or a proximity-based operation of the movable barrier operator system 100. Each of these different operations are discussed in more detail below.

State Change Operation

The state change system operation for the movable barrier 106 can be performed with respect to each of the user devices 200 and 300, the vehicle 400, and pet 500. For example, the processor 125 may be configured to cause the movable barrier operator 102 to open the movable barrier 106 when one or more of the ultra-wideband devices 203, 303, 402, or 502 enter a predetermined range of the ultra-wideband devices 132. Further, the processor 125 may be configured to cause movable barrier operator 102 to close the movable barrier 106 when the one or more of the ultra-wideband devices 203, 303, 402, 502 is farther than the predetermined range from the ultra-wideband devices 132. As an example in this regard, the processor 125 may cause the movable barrier operator 102 to open the movable barrier 106 when the in-vehicle device 402 is detected within range 134 (see FIG. 2) and to close the movable barrier 106 when the in-vehicle device 402 subsequently moves outside of the range 134.

Further, in some embodiments, the processor 125 can select one of closing the movable barrier 106, opening the movable barrier 106, or no action based on the current state of the movable barrier 106 and a location and a moving direction of the ultra-wideband devices 203, 303, 402, or 502 that is detected. For example, where the detected one of the ultra-wideband devices 203, 303, 402, or 502 is inside the garage 101 and moving towards the movable barrier 106, the processor 125 can select opening the movable barrier 106 as the state change operation when the current state of the movable barrier 106 is closed and select no action when the current state of the movable barrier 106 is open. In some embodiments, this functionality may be suppressed for the ultra-wideband device 402 inside the vehicle 400 because of the speed at which the vehicle travels. Instead, the vehicle 400 may display a warning that the movable barrier 106 is not open. Additionally, where the detected one of the ultra-wideband devices 203, 303, 402, or 502 is inside the garage 101 and moving away from the movable barrier 106, such as moving into the associated home (e.g. for the ultra-wideband devices 203, 303, and 502) or down the driveway, the processor 125 can select closing the movable barrier 106 as the state change operation when the current state of the movable barrier 106 is open and select no action when the current state of the movable barrier 106 is closed. Further, where the detected one of the ultra-wideband devices 203, 303, 402, or 502 is outside the garage 101 and moving toward the movable barrier 106, the processor 125 can select opening the movable barrier 106 as the state change operation when the current state of the movable barrier 106 is closed and select no action when the current state of the movable barrier 106 is open. Finally, where the detected one of the ultra-wideband devices 203, 303, 402, or 502 is outside the garage 101 and moving away from the movable barrier 106, the processor 125 can select closing the movable barrier 106 as the state change operation when the current state of the movable barrier 106 is open and select no action when the current state of the movable barrier 106 is closed.

In some embodiments, the preconfigured range for which the processor 125 triggers the state change operation can be different for each of the ultra-wideband devices 203, 303, 402, or 502. For example, the preconfigured range associated with the in-vehicle ultra-wideband device 402 of vehicle 400 may be greater than the preconfigured range associated with the user devices 200 and 300 and the pet 500 to account for the faster operating speed of the vehicle 400 as compared to the moving speed for users of the user devices 200 and 300 and the pet 500.

In some embodiments, when the state change system operation includes opening the movable barrier 106, the detected ultra-wideband device is the ultra-wideband device 502 associated with the pet 500, and none of the ultra-wideband devices 203, 303, or 402 are additionally detected, the processor 125 may direct the movable barrier operator 102 to partially open the movable barrier 106 to a preprogramed height sufficient to allow ingress and/or egress of the pet 500 from the garage 101. In these embodiments, when the door 506 is an access point to the garage 101, the processor 125 can act in conjunction with the pet access apparatus 504 to enable the pet 500 to move between the secured area 514, the garage 101, and the area outside of the garage 101.

Anti-Entrapment Operation

The anti-entrapment operation for the movable barrier operator system 100 can be performed in connection with the ultra-wideband devices 203, 303, 402, or 502 as well as other ultra-wideband signals belonging to unrecognized devices/device. For example, in some embodiments, the anti-entrapment operation can replace and/or supplement functionality of the photo eye system 120 and force sensing operations of the movable barrier operator system 100. In particular, the anti-entrapment operation can include stopping or reversing an in-process close operation of the movable barrier 106 whenever any ultra-wideband signal that is detected by the ultra-wideband devices 130A and 130B and the ultra-wideband devices 132 indicate that a broadcasting ultra-wideband device, including but not limited to the ultra-wideband devices 203, 303, 402, or 502, is located within a preconfigured anti-entrapment distance of the movable barrier 106. In this way, the movable barrier operator system 100 can limit the risk of the movable barrier 106 being closed on a person associated with the ultra-wideband signals being broadcast and received by the ultra-wideband devices 130A and 130B and/or the ultra-wideband devices 132. As an example, a smartphone in a user's pocket or a smart collar of a pet in an entrapment zone associated with the movable barrier 106 may cause the processor 125 to reverse a closing movable barrier 106 upon one of the devices 132 detecting an ultra-wideband signal emitted from the smartphone that is within a predetermined distance of the device 132.

Further, in a gate operator embodiment, the anti-entrapment operation can be utilized to replace or supplement detection of a vehicle. For example, the anti-entrapment operation using ultra-wideband devices can be used to supplement or replace inductance loops (e.g., exit, shadow, and interrupt loops) typically used to limit the risk of a gate being closed on the vehicle.

Additionally or alternatively the anti-entrapment operation can include activating a notification apparatus (e.g., a light and/or a speaker) when the broadcasting ultra-wideband device is detected: (1) in a restricted area of or proximate to the garage 101; (2) approaching from a certain direction; and/or (3) as being present at a specific location for greater than a predetermined amount of time. Further, in some embodiments, the notification apparatus may be activated in conjunction with stopping and/or reversing the in-process close operation so as to additionally alert the person associated with the broadcasting ultra-wideband device of the closing movable barrier 106.

Proximity-Based Operation

The proximity-based operation of the movable barrier operator system 100 can include operations of the movable barrier operator 102 that are typically restricted to confirmed line-of-sight or proximity to the movable barrier operator 102. In some embodiments, these features can include door position limit learning, force learning, and/or transmitter learning of the movable barrier operator 102. Thus, the movable barrier operator system 100 limits access to these features via remote interfaces on the user devices 200 and 300 to situations where the processor 125 has determined that the user devices 200 and 300 are within the area 136 that is proximate to the movable barrier operator 102. As one example, the movable barrier operator 102 may communicate a credential, such as a code or a token, to the user device 200 via a Bluetooth radio of the ultra-wideband device 130A, the user provides a user input regarding changing a limit position of the movable barrier 106 to an application running on the user device 200, and the user device 200 communicates a command based upon the user input and containing the code to the movable barrier operator 102 via the ultra-wideband device 203. The movable barrier operator 102 changes the limit position of the movable barrier 106 because the command is close enough to the movable barrier operator 102 to receive the ultra-wideband signal.

Various embodiments for limiting access to the proximity-based feature are described herein. For example, in some embodiments, the processors 208 and 308 of the user devices 200 and 300, respectively, can be configured to receive an enabling communication from the processor 125 when the ultra-wideband devices 203 and/or 303 are determined to be within the area 136 that is proximate to the movable barrier operator 102. In response to the enabling communication, the processors 208 and 308 can enable previously disabled limit learn, force learn, or similar features via the user interface 204 and/or user interface 304 (such as displayed on a touchscreen of the user interface 204, 304). For example, when the user device 200 is located outside the area 136 and the user device 300 is located inside the area 136 as seen in FIG. 2, the processor 308 will enable the limit learn, force learn, or similar features within the user interface 304 while the processor 208 refrains from doing likewise. In some embodiments, disabling the features on the user interfaces 204 and/or 304 can include greying out or not presenting options related to those features.

In some embodiments, the distance D (see FIG. 2) may be a preset distance programmed into the movable barrier operator 102. Additionally or alternatively, the distance D may be modifiable using an application running on, for example, the user devices 200 and/or 300. In some embodiments, the application can enable the user to select from different preset values for the distance D and/or to input a fully customized value via the user devices 200 and/or 300. Customization of the distance D can be helpful to accommodate varying possible heights of the movable barrier operator 102 within the garage 101.

Additionally or alternatively, the limit learn, force learn, or similar features can remain enabled within the user interfaces 204 and/or user interface 304 and the processor 125 can be configured to only execute the limit learn, force learn, or other processes when the user device 200 and/or 300 that sent a command to execute the process is within the area 136. For example, when the user device 200 is located outside the area 136 and the user device 300 is located inside the area 136 as seen in FIG. 2, the processor 125 will perform the limit learn, force learn, or similar processes when instructed to do so by the user device 300 and will ignore any similar instructions received from the user device 200. In some embodiments, the processor 125 can send an error command to the user device 200 or 300 whenever the limit learn, force learn, or other processes are not executed because of a lack of proximity to the movable barrier operator 102.

Further, in some embodiments, the processor 125 can refrain from executing the limit learn, force learn, or other processes so long as any ultra-wideband signals are detected outside the area 136 and/or within a predetermined distance of the movable barrier 106. For example, when the user device 200 and the pet 500 are located outside the area 136 and the user device 300 is located inside the area 136 as seen in FIG. 2, the processor 125 may refrain from executing the limit learn, force learn, or similar processes even though the user device 300 is present within the area 136. In some embodiments, the processor 125 can also refrain from transmitting the enabling communication to the user device 300 so long as the user device 200 and the pet 500 are also located outside the area 136. Further still, in some embodiments, the processor 125 can terminate an in-progress limit learn, force learn, or similar process in the event that the user device 200 and/or 300 that sent a command to execute the process leaves the area 136 and/or when any other ultra-wideband signal broadcaster is detected outside the area 136 or within a predetermined distance of the movable barrier 106.

In some embodiments, the proximity verification using ultra-wideband signals can be supplemented and/or verified by additional processes. For example, the processor 125 can (1) determine whether the user device 200 and/or 300 is connected to a local Wi-Fi network or access point, (2) determine whether the user device 200 and/or 300 is Bluetooth paired with the movable barrier operator 102, (3) prompt the user device 200, 300 to ask the user to scan a barcode on the movable barrier operator 102; and/or (4) employ a camera-based technique such as using a camera of the movable barrier operator 102 or a stand-alone camera to perform person/identity recognition on the user in the garage 101.

As an example, the user device 200 may be used to install and setup the movable barrier operator 102 if the user device 200 is within the area 136. More specifically, installation of the movable barrier operator 102 may include the user opening the box containing the movable barrier operator 102, connecting the movable barrier operator 102 to a power source, and pairing the user device 200 to the movable barrier operator 102 via an application running on the user device 200 and one or more ultra-wideband signals communicated between the user device 200 and the movable barrier operator 102. The application may provide step-by-step instructions for installing the movable barrier operator 102 to guide the user through the process.

Once the movable barrier operator 102 is installed, the user may setup the movable barrier operator 102 to enable various operations that utilize ultra-wideband signals using an iterative process. The user may first position the user device 200 near the movable barrier operator 102 and provide a user input to the user device 200 such as a change to a force limit setting. Next, the user moves the user device 200 farther away at set distance intervals and adjusts the force limit setting at each interval and the processor 125 associates a distance calculated from time of flight of the received ultra-wideband signals from the user device 200 and the distance intervals. In this manner, the user may validate the user device 200 is able to control the operability of the movable barrier operator 102 associated with ultra-wideband signals at varying distances from the movable barrier operator 102.

As another example, the user device 200 may be within the range 134 of the movable barrier operator 102 but outside of the area 136, such as if the user associated with the user device 200 is sitting in a chair near the movable barrier 106 watching the user's child play basketball in the driveway that leads to the garage 101. The processor 125 may operate a timer and be programmed to automatically close the movable barrier 106 after the movable barrier 106 has been open for more than a predetermined period of time, such as ten minutes. The processor 125 may be programmed to override the automatic closing of the movable barrier 106 as long as the user device 200 remains within the range 134 of the movable barrier operator 102 such that the movable barrier 106 remains open while the user sits in the chair near the movable barrier 106.

Determine a Status of the Movable Barrier

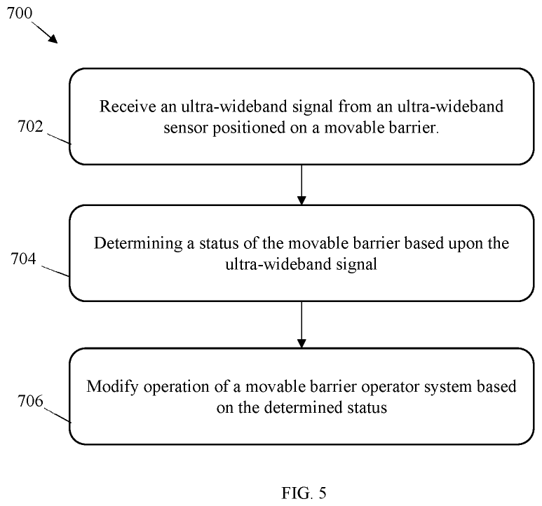

With reference to FIG. 5, the movable barrier operator system 100 may also be used in conjunction with a method 700. The method 700 can include receiving 702 an ultra-wideband signal from the ultra-wideband devices 132 positioned on the movable barrier 106 at the ultra-wideband devices 130A and/or 130B. The method 700 includes the processor 125 determining 704 a status of the movable barrier 106 based upon the received ultra-wideband signal and modifying 706 operation of the movable barrier operator system 100 based on the determined status. The status of the movable barrier 106 may include, for example, door position (e.g., open, closed, intermediate), whether the door is moving, a direction of movement, and/or a speed or velocity of the movable barrier 106.

For example, the processor 125 may utilize the received ultra-wideband signal to determine a current position of the movable barrier 106 and cause the movable barrier operator 102 to stop movement of the movable barrier 106 when an opened, closed, or intermediate position of the movable barrier 106 is detected. Further, the processor 125 may cause the movable barrier operator 102 to stop or reverse movement of the movable barrier 106 and operate the notification apparatus (e.g., a light and/or a speaker of the movable barrier operator 102) when the processor 125 determines that a travel of the movable barrier 106 exceeds the limit positions and/or if motion of the movable barrier 106 is stopped when the movable barrier operator 102 expects the movable barrier 106 to be moving (e.g., stall entrapment protection). In some embodiments, the processor 125 can utilize the received ultra-wideband signals to detect that the movable barrier 106 has been derailed due to a vehicle colliding with the movable barrier 106, wind, or other environmental occurrence, and/or a mechanical failure such as breakage of the drum and cable mechanism 110 or the torsion spring 108.

Further still, the processor 125 can instruct the movable barrier operator 102 to execute a stop or brake motion of the movable barrier 106 when the received ultra-wideband signal indicates unexpected motion of the movable barrier 106. In these embodiments, the processor 125 may also trigger the notification apparatus and/or communicate a notification to a user device 200, 300 such as an SMS message or an application/push notification to indicate the unexpected movement of the movable barrier 106.

Additionally, the processor 125 can utilize an ultra-wideband signal received by one or more of the ultra-wideband devices 132 to deduce an actual moving speed of the movable barrier 106 as the movable barrier 106 moves and adjust operation of the movable barrier operator 102 to ensure that the speed of the movable barrier 106 is maintained within preconfigured regulatory guidelines regardless of output sprocket size, linkage geometry, or other potentially variable mechanical attributes of the movable barrier operator system 100. Similarly, the processor 125 can utilize the ultra-wideband signals received from one or more of the ultra-wideband devices 132 to detect oscillations or other unexpected motion during movement of the movable barrier 106 and adjust operation of the movable barrier operator 102 to smooth out the identified oscillations.

It will also be appreciated that further embodiments where additional processors that are separate and/or remote from the processor 125 may utilized to supplement and/or replace the operations described above as being performed or initiated by the processor 125. Such additional processor may include the processors 208 and 308 of the user devices 200 and 300, processors of local computers or servers, cloud server computers, or the like.

Uses of singular terms such as “a,” “an,” are intended to cover both the singular and the plural, unless otherwise indicated herein or clearly contradicted by context. The terms “comprising,” “having,” “including,” and “containing” are to be construed as open-ended terms. It is intended that the phrase “at least one of” as used herein be interpreted in the disjunctive sense. For example, the phrase “at least one of A and B” is intended to encompass A, B, or both A and B.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A system comprising:
a movable barrier operator configured to open and close a movable barrier;
at least one ultra-wideband device associated with the movable barrier operator and electrically configured to receive ultra-wideband radio frequency signals; and
a processor operatively connected to the at least one ultra-wideband device and configured to use the ultra-wideband radio signals to determine a status of the movable barrier.

2. The movable barrier operating system of claim 1 wherein the status of the movable barrier includes one of opened, closed, opening, closing, stopped, or an intermediate position between opened and closed.

3. A method of operating a system, the method comprising:
determining a distance between a source of a detected ultra-wideband signal and a specific location;
determining an identity of a source of the ultra-wideband signal; and
performing a movable barrier operator system operation based on the distance and the identity of the source, the movable barrier operator system including one or more of a state change operation, an anti-entrapment operation, and/or a proximity-based operation of the movable barrier operator system.
